(19) United States
(12) Patent Application Publication
(10) Pub. No.: US 2008/0176698 A1
(43) Pub. Date: Jul. 24, 2008

(54) Wheel Set Assembly

(76) Inventor: Joan Moreno PUJAL, Solsona (Lleida) (ES)

Correspondence Address: STURM & FIX LLP, 206 SIXTH AVENUE, SUITE 1213, DES MOINES, IA, 50309-4076, US

(21) Appl. No.: 12/013,747

(22) Filed: Jan. 14, 2008

(30) Foreign Application Priority Data
Jan. 19, 2007 (ES) 200700154

(51) Int. Cl. F16H 1/28

(52) U.S. Cl. 475/5

(57) ABSTRACT

An improved wheel set assembly that has a fork or cradle to turn the platform through an angle in relating to the vertical axis, two independent, motorised internally hollow wheels located on the same central horizontal axis and that are kept apart at a certain distance, which are supported by an internal hollow support, an activating motor connected to said fork or cradle, and that it is fitted with an internal reduction mechanism and an internal differential mechanism so that under the conditions of the vehicle making a change of trajectory, one of the motorised wheels has the ability to turn at a different speed to the other motorised wheel, both wheels maintaining the same torque, said reduction mechanism and internal differential mechanism being housed in the cavity formed on the inside of the support of the two motorised wheels.

### OBJECT OF THE INVENTION

The object of this present Invention patent is an improved wheel set assembly that incorporates appreciable innovations and advantages in relation to other vehicles with the same purpose.

More specifically, the invention refers to an improved wheel set assembly, particularly for the movement of transport vehicles and other similar for heavy loads, with a considerable size that is characterised by its robustness and reliability.

### BACKGROUND TO THE INVENTION

The existence of autonomous vehicles for the movement of large loads has been known for some years, such as those which are used inside industrial enclosures for the automated movement of large sized dies. This type of vehicles are usually made up of a horizontal platform onto which the large load to be moved is placed and with a means of movement made up of several sets of wheels that are required for the handling of large loads.

These sets of wheels are made up of means of activation that allow the movement of the wheels, however, said activation devices occupy considerable space hence they are exposed to knocks and dirt, in such a way that it involves the carrying out of higher maintenance for the sets of wheels. In addition, another disadvantage is centred around the moment of carrying out a turn of the autonomous vehicle in relation to the vertical axis as it requires the use of additional devices to allow the turn of the vehicle which, in certain cases, consists of the use of pistons or similar elements that slightly raise the autonomous vehicle to make the subsequent turn of the stated vehicle in the air. Otherwise, the not having said additional devices available would mean that the known wheel assemblies will not allow the vehicle to make sharp changes of direction.

### DESCRIPTION OF THE INVENTION

The present invention has been developed for the purpose of providing a wheel set assembly that solves the previously stated disadvantages, moreover, providing other additional advantages that will be clear from the description which is attached below.

It is therefore the aim of the invention to provide an improved wheel set assembly, particularly for the movement of transport vehicles and similar for heavy loads, that is characterised by the fact that it has a fork or cradle to turn the platform through an angle in relation to the vertical axis, two independent internally hollow motorised wheels located on the same central horizontal axis and separated by a certain distance, which are supported by an internally hollow support, an activating motor connected to said fork or cradle, and that it is fitted with an internal reduction mechanism and an internal differential mechanism so that under the conditions of the vehicle making a change of trajectory, one of the motorised wheels has the ability to turn at a different speed to the other motorised wheel both wheels maintaining the same torque, said internal reduction mechanism and internal differential mechanism being housed in the cavity formed on the inside of the support of the two motorised wheels.

According to another aspect of the invention, the internal reduction mechanism of the wheel assembly has three planetary gear assembly systems, two of said planetary systems being respectively coupled to each one of the motorised wheels, and the third planetary system being coupled to the differential mechanism.

By preference, the said third system is linked to a longitudinal axis coupled to the activation motor whose task is to transmit the movement to the rest of the elements of the mobile components.

In regard to the differential mechanism, this is made up of at least two conical crowns, so that one of the crowns is connected to one of the planetary systems coupled to a wheel, whilst the other conical crown is connected to the other planetary system coupled to the other wheel.

Advantageously, the fork or cradle as some means of water tightness that prevents the entry of dirt and leaks of the lubricant for the greasing of the internal mechanical components, for example, double lip gaskets.

Thanks to these characteristics, an autonomous vehicle is obtained for the transporting of heavy loads whose wheel sets are compact (this means, the working mechanisms are arranged on the inside) and are modular, having a considerably reduced manufacturing cost and which allow controlled movements to be carried out and without any lack of continuity in any direction on the plane (cross movements, movements at an angle, pivoting on differing predetermined centres) without the need to unload the elements being transported and without excess effort or the help of additional elements. In addition, and advantageously the internal space of the wheel is watertight and allows the greasing of the differing mechanisms housed without the possibility of lubricant leaks.

Advantageously, the three planetary systems of gears and the differential mechanism are aligned on the same longitudinal axis.

Additionally, under the condition of a change of trajectory of the vehicle, the two motorised wheels have the capacity to turn simultaneously in opposing directions when all of the assembly pivots on its vertical axis.

Other characteristics and advantages of the wheel assembly object of this present invention will become clear from a description of a preferred embodiment, but it is not exclusive, the drawings that are attached are by way of illustration but without being in any way limiting.

### BRIEF DESCRIPTION OF THE DRAWINGS

FIG. 1 shows a perspective view of an autonomous vehicle for the transportation of heavy loads that incorporates the wheel set assembly according to the present invention.

FIG. 2 shows a transversal section of the wheel assembly of the vehicle of the invention.

FIG. 3 shows a transversal section of the above wheel assembly of the vehicle in a larger scale and in which several parts have been removed to give greater understanding.

FIG. 4 shows a detail in an increased scale of a portion of the transversal section of the above figure; and

FIG. 5 shows a plan view from above the wheel set assembly.

### DESCRIPTION OF A PREFERRED EMBODIMENT

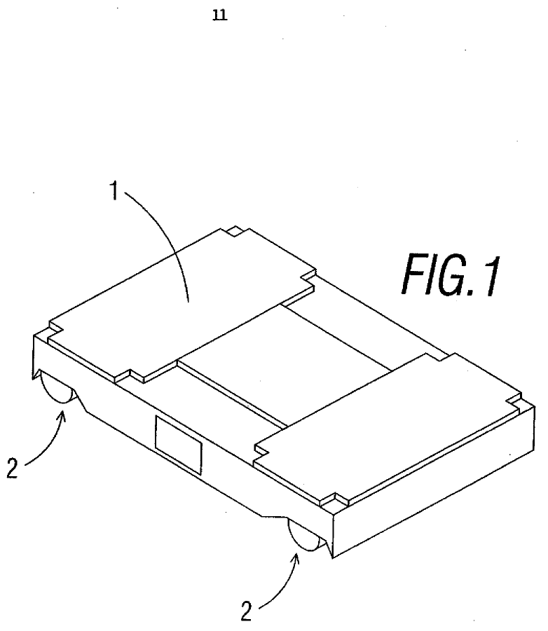

In FIG. 1 an embodiment is shown of an autonomous vehicle for the transport of heavy loads, such as mould, dies, etc., that is made up of a platform (1) that is appreciably horizontal that supports the load to be transported and a means of movement that consists of four wheel set assemblies corresponding with the aim of the invention, referenced in a general nature with the number (2) located at each corner of the platform (1), which are detailed below.

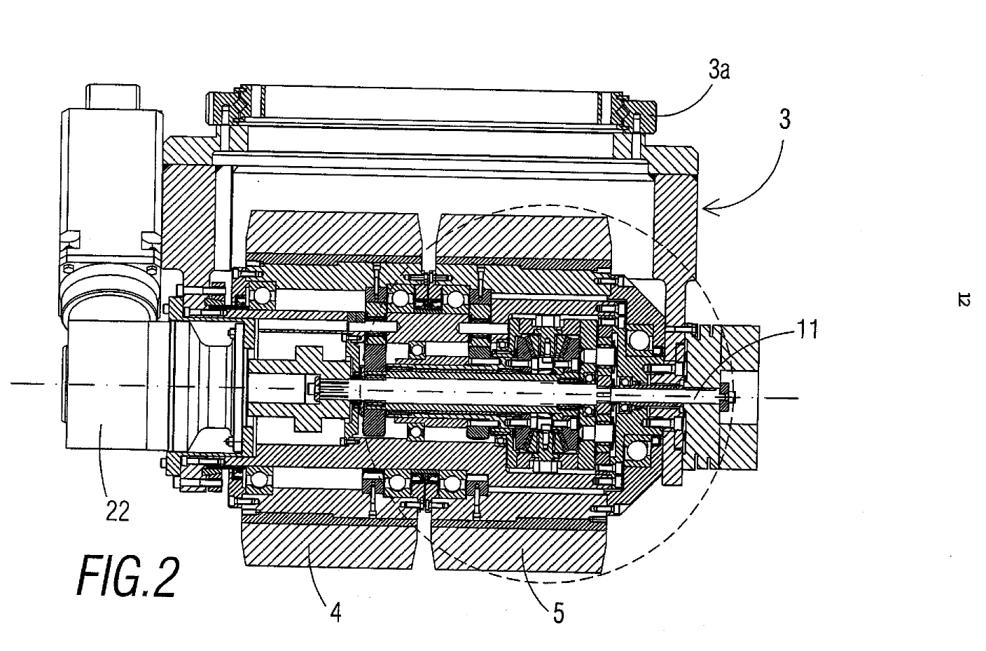

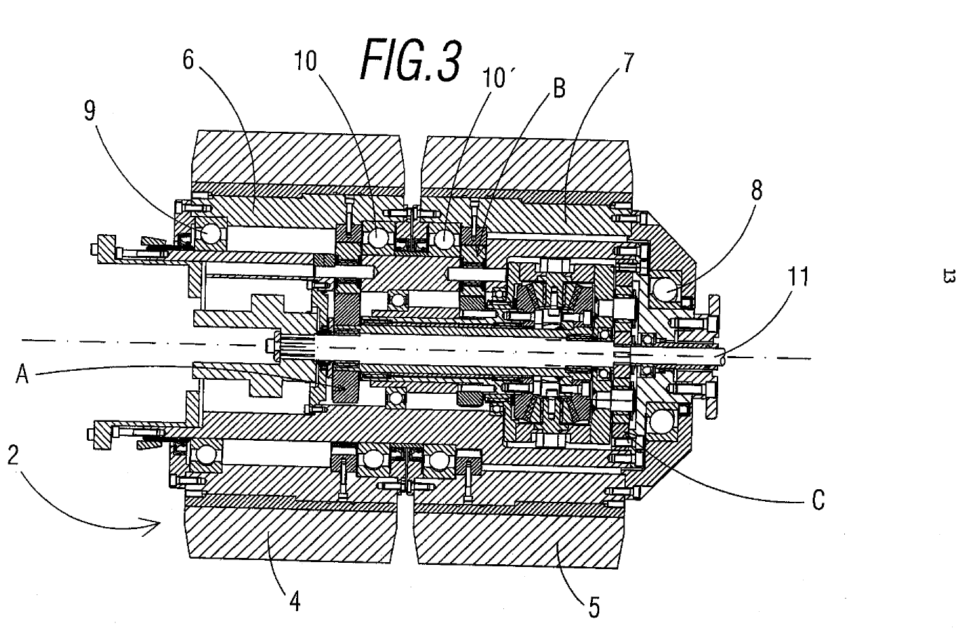

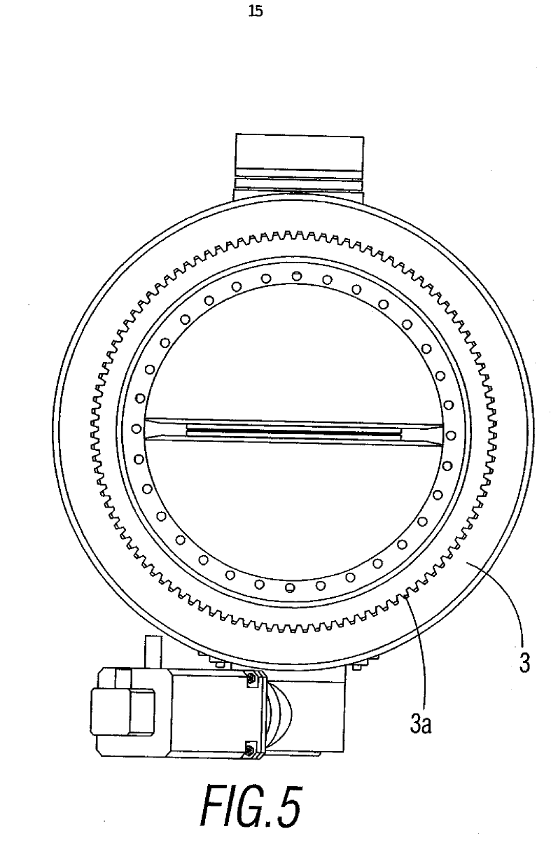

As can be seen in FIGS. 2, 3 and 4, each wheel assembly (2) is made up of an upper fork or cradle (3) that allows the angular turning of the platform in relation to its vertical axis, two internally hollow independent motorised wheels (4 & 5) located on the same central horizontal axis and separated by a certain distance which are supported by supports (6 & 7) or internally hollow rims that include the corresponding bearings (8, 9, 10 & 10′). In addition an activation motor (22) is fitted (being able to be of a hydraulic or pneumatic type, or any other suitable type) connected to the stated fork or cradle (3), and which is provided with an internal reduction mechanism and an internal differential mechanism (D) so that under the conditions of a change of vehicle trajectory, one of the motorised wheels (4 & 5) turns in an opposite direction and at a different speed to the other motorised wheel (the torque of both wheels being the same), said internal reduction mechanism and said internal differential mechanism being housed in the cavity formed on the inside of the supports (6 & 7) of the two motorised wheels (4 & 5). The fork or cradle (3) includes a section (3a) in the upper part by way of being a toothed crown (see FIG. 5) in order to be coupled to a gear (not shown) connected to a platform (1) to allow the operation of a turn in relation to the vertical axis.

Each one of the motorised wheels (4 & 5) is fitted with a solid polyurethane tread.

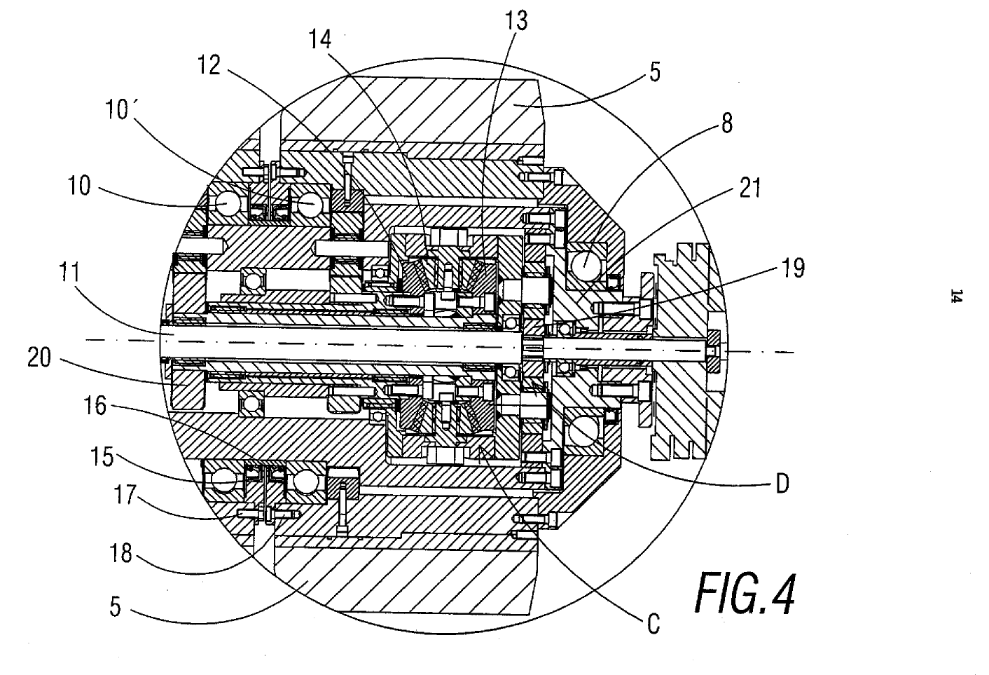

The internal reduction mechanism has three planetary systems of gears (A, B & C), two of said planetary systems (A & B) being coupled to each one of the motorised wheels (4 & 5) respectively, and the third planetary system (C) being coupled to the internal differential mechanism (D) as can be seen more clearly in FIG. 4. Said third planetary system (C) is linked to a longitudinal axis (11) that is connected to the activation motor. Each one of the stated planetary system (A, B & C) is made up of an external toothed crown, a central solar gear and two satellite gears.

In regard to the internal differential mechanism (D), and as can be seen more clearly in FIG. 4, it is basically made up of two conical crowns (12 & 13) and a central satellite differential gear (14), so that when they engage, one of the crown (12) transmits the movement to one of the planetary systems coupled to one wheel, whilst the other conical crown (13) transmits the movement to the other planetary system coupled to the other wheel. Greater detail in regard to the working of said internal differential mechanism (D) is not going to be gone into as it is the same working concept as any other differential concept known in the state of the art. This internal differential mechanism (D) distributes the torque between both wheels (4 & 5) and allows its opposing turn to be made with complete freedoms when all of the system pivots on the vertical axis.

Additionally and to prevent leaks of the lubricant from the inside of the wheel assembly some means of water tightness is provided. Such means of water tightness are made up by gaskets of the double lip type and O-ring seals (15 & 16) that are located on the periphery in the space between the two wheels (4 & 5) and at the opposite ends, which are held onto the supports (6 & 7) by their respective bolts (17 & 18) in such a way that the inside of the wheel assembly (2) is completely water tight and leak proof.

It must also be mentioned that the assembly (2) of the invention internally has a support element (21) simultaneously holding the turning gears of both wheels and the fork or cradle (3), acting as a main support axle and gearbox (see FIG. 4).

Next, the working of one of the wheel assemblies is going to be detailed according to the invention:

In the first place, when the activation motor is activated it makes the longitudinal axis (11) turn in such a way that its transfers the movement to the planetary system of the gears (C) by means of the central solar gear (19). Said planetary system (C) transfers its turning movement to the internal differential mechanism (D) making the differential satellite gear (14) turn and in turn engaging with the two conical crowns (12 & 13). Next, the conical crown (12) transfers its movement to the planetary system (B) making it turn the wheel (5) support (7) whilst on the other hand, the conical crown (13) transfers its movement to the planetary system (A) making the support or rim (6) of the wheel (4) turn by means of the central solar gearing (20). In the case of a straight line movement of the independent vehicle (either backwards or forwards), the turn torque of the conical crowns (12 & 13) is equal to zero whilst in a situation where there is a change of direction of the vehicle, owing to the fact that both wheels must turn, each wheel has a different tangential velocity, it thus being necessary to have an internal differential mechanism (D) to counteract this difference and so that each wheel keeps the torque, in such a way that it can turn against its vertical axis.

The details, shapes, sizes and other accessorial elements, likewise the materials used in the manufacture of the wheel set assembly of the invention can be appropriately substituted by others that are technically equivalent and do not stray away from the essentiality of the invention or the scope defined by the claims that are included below.

1. An improved wheel set assembly specially for transport vehicles and similar for heavy loads, wherein each wheel assembly comprises:
a fork or cradle to make an angular turn of the platform in relation to its vertical axis, two internally hollow independent motorised wheels located on the same central horizontal axis and separated by a certain distance, which are supported by internally hollow supports
an activation motor that is fitted to the stated fork or cradle, and
which is provided with an internal reduction mechanism and an internal differential mechanism (D) so that under the conditions of a change of vehicle trajectory, one of the motorised wheels is able to turn at a different speed to the other motorised wheel with both wheels still being able to maintain the same torque; and
said internal reduction mechanism and said internal differential mechanism (D) being housed in the cavity formed on the inside of the supports of the two motorised wheels.

2. A wheel set assembly according to claim 1, wherein the internal reduction mechanism has three planetary gearing systems (A, B & C), two of said planetary systems (A & B) being respectively coupled to each one of the motorised wheels, and the third planetary system (C) being coupled to the internal reduction mechanism (D).

3. A wheel set assembly according to claim 2, wherein the third planetary system (C) is linked to a longitudinal axis connected to the activation motor (22).

4. A wheel set assembly according to claim 1, wherein the internal differential mechanism (D) is made up of at least two conical crowns and differential satellite gearing so that one of the crowns is connected to one of the planetary systems connected to a wheel, whilst the other conical crown is connected to the other planetary system coupled to the other wheel.

5. A wheel set assembly according to claim 1, wherein the fork or cradle is fitted with some means of water tightness.

6. A wheel set assembly according to claim 5, wherein the stated means of water tightness has a plurality of gaskets being of the double lip type and also O-ring seals.

7. A wheel set assembly according to claim 1, wherein the fork or cradle has a toothed crown section on its upper part so as to engage with a gear so as to enable the turning movement to its vertical axis.

8. A wheel set assembly according to claim 1 wherein the three planetary gearing systems (A, B & C) and the internal differential mechanism (D) are aligned on the same longitudinal axis.

9. A wheel set assembly according to claim 1, wherein in a situation of a change of direction of the vehicle, the two motorised wheels have the ability to simultaneously turn in opposite directions when the whole assembly is pivoting on its vertical axis.
